(19) United States
(12) Patent Application Publication
(10) Pub. No.: US 2013/0170044 A1
(43) Pub. Date: Jul. 4, 2013

(54) METHOD AND STRUCTURE OF OPTICAL THIN FILM USING CRYSTALLIZED NANO-POROUS MATERIAL

(71) Applicant: RAYDEX TECHNOLOGY, INC., Lexington, MA (US)

(72) Inventors: Frank W. Mont, Troy, NY (US); JIngqun Xi, Lexington, MA (US)

(73) Assignee: RAYDEX TECHNOLOGY, INC., Lexington, MA (US)

(21) Appl. No.: 13/734,469

(22) Filed: Jan. 4, 2013

Related U.S. Application Data
(60) Provisional application No. 61/582,829, filed on Jan. 4, 2012.

(51) Int. Cl. G02B 1/10

(52) U.S. Cl. CPC G02B 1/10; Y10S 977/70; B82Y 20/00
USPC 359/580; 427/162; 427/596; 977/700

(57) ABSTRACT

Techniques for an optical filter having robust crystallized nano-porous layers are disclosed herein. According to at least one embodiment, the optical filter includes a light-transmitting substrate and an optical coating. The optical coating is deposited on the light-transmitting substrate. The optical coating includes at least one crystallized nano-feature layer. The at least one crystallized nano-feature layer is deposited using high temperature oblique angle deposition and has a refractive index lower than a refractive index of the light-transmitting substrate.

### RELATED APPLICATIONS

This application claims the benefit of U.S. Provisional Application No. 61/582,829, having a filing date of Jan. 4, 2012, which is incorporated herein by references.

### FIELD OF THE INVENTION

This invention relates generally to optical filters. In particular, this invention relates to optical filters having crystallized nano-porous layers.

### BACKGROUND

Optical filters are utilized in many fields including optical microscopy, optical windows, high-power illumination systems, and optoelectronics. Optical filters are created by implementing optical thin-film layers with highly reflective, partially reflective and anti-reflective properties. Many methods exist for fabricating optical filters.

The most common method for fabricating thin-film optical filters includes using dense thin-film layers in which each layer contains a particular material with a particular refractive index. By using thin-film layers with different refractive index values, optical thin-films having anti-reflective and highly reflective properties can be realized. However, the optical performance of these conventional thin-film coatings is limited, due to the limitation of selection of refractive index values (restricted by material availability and choice) that can be used in the dense optical thin-film. To compensate for this limitation, conventional dense thin-film optical filters contain many different layers and materials in order to obtain a desired optical performance. Unfortunately, the various material coatings and large coating thickness increases cost and affects the robustness of the filters.

The use of moth-eye surface structures is another choice for making anti-reflective optical filters. Their surface features can be approximated as a graded refractive index layer in which the refractive index decreases as a function of distance away from the substrate. Although broadband anti-reflective (AR) properties have been demonstrated for substrates treated with moth-eye structures, their performance and implementation are limited. The fabrication of nano or micro moth-eye structures involves precise lithography and etching steps and is often a costly process. Moreover, moth-eye structures cannot achieve ideal graded index profiles due to their lack of thickness and refractive index control.

The use of nano-porous thin-film optical filters can provide superior optical performance compared to conventional dense thin-film optical filters. The precise thickness and refractive index tunability of nano-porous thin-films allow near-ideal optical structures to be realized. By fabricating nano-porous thin-films on substrates, highly reflective or anti-reflective coatings can be realized. However, the lack of robustness and non-ideal optical performance of existing nano-porous thin-film optical filters has limited their use and impact in the optics field.

### SUMMARY

At least one embodiment of the present invention discloses a design and a fabrication method to make robust, crystallized nano-porous layers in optical filters. These optical thin-film filters are realized by creating robust optical thin films enabled by at least one or more crystallized nano-porous layers on a substrate, optical window, light source, or detector. The crystallized nano-porous features can be transparent in the UV, visible, and IR spectra. The crystallized nano-porous thin-film optical filter is deposited or grown on the substrate, optical window, light source, or detector. The robust crystallized nano-porous layer is fabricated to enhance the overall robustness and optical performance of the optical filter. Robust and high performance optical filters are needed in many applications and areas including lighting, solar, and vision systems.

In one embodiment, the fabrication method is revealed by the use of high temperature shadowing deposition. The high temperature or energy during crystallized nano-shadowing creates the crystallized nano-porous layer. These robust crystallized nano-porous layers enable substantial robustness improvements for the thin-film optical filter including abrasion, adhesion, immersion, and temperature-tolerance while providing superior optical performance compared to traditional dense or other nano-porous optical filters. The simple fabrication steps needed for producing the crystallized nano-porous layers allows for low-cost manufacturing.

In another embodiment, both robust, crystallized nano-porous layers and dense layers are incorporated into an optical filter. The dense layers aid in both optical and mechanical performance. The dense layer can have a higher effective refractive index compared to the robust crystallized nano-porous layer. Scratch-resistant hard coats can be added to provide additional environmental and mechanical robustness. The dense and crystallized nano-porous layers can form optical thin-film pairs and be used in various optical filter designs. The dense layer can be deposited or grown on top of, below, or between the crystallized nano-porous layers.

In yet another embodiment, both non-crystalline and robust, crystallized nano-porous layers are incorporated into an optical filter. The non-crystalline nano-porous layers can be used to increase the range of materials and refractive index values desired in an optical filter. The non-crystalline nano-porous layer can be deposited or grown on top of, below, or between the crystallized nano-porous layers.

According to one embodiment, an apparatus is provided. The apparatus includes a light-transmitting substrate and an optical coating. The optical coating is deposited on the light-transmitting substrate. The optical coating includes at least one crystallized nano-feature layer. The at least one crystallized nano-feature layer is deposited using high temperature oblique angle deposition and has a refractive index lower than a refractive index of the light-transmitting substrate.

According to another embodiment, another apparatus is provided. The apparatus includes a light-transmitting substrate and an optical coating. The optical coating is deposited on top of the light-transmitting substrate. The optical coating includes a plurality of pairs of alternating thin film layers. At least one thin film layer of each pair of alternating thin film layers is a crystallized nano-feature layer deposited using high temperature oblique angle deposition. Each pair of alternating thin film layers has two thin film layers that have different refractive indices.

According to yet another embodiment, still another apparatus is provided. The apparatus includes a light-transmitting substrate and an optical coating. The optical coating is deposited on the light-transmitting substrate. The optical coating includes a crystallized nano-feature layer. The crystallized nano-feature layer is deposited by a process including: generating a material flux by a deposition system having a nominal flux direction toward a substrate, wherein a tilt angle between the nominal flux direction and a plane normal vector of the substrate is substantially larger than zero, depositing material on the substrate by the material flux to grow nano-porous features, and heating the substrate to a predetermined temperature such that the nano-porous features at least partially crystallize on the substrate.

The optical transparency and performance of crystallized nano-porous layers outperform amorphous nano-porous layers. Crystallized nano-porous layers have fewer defects that result in optical absorption compared to amorphous nano-porous layers. This will result in superior optical thin-film filters compared to current state-of-the-art technologies.

The invention disclosed herein uses one or more highly robust crystallized nano-porous layers on a substrate. These crystallized nano-porous can withstand high temperatures because the nano-features can expand without adding stress to the layers beneath or above them. This will release the stress induced by the mismatch of the coefficients of thermal expansion between the materials above and below the crystallized nano-porous layer. This can ensure that the optical thin-film layers are crack-free and stress-free.

The use of highly robust nano-porous thin-film optical filters such as a partially or fully crystallized nano-porous layer on optical windows or substrates provides strong adhesion to the optical windows and substrates.

The invention disclosed herein provides a robust fabrication design and method that will allow for the immersion of nano-porous coatings without mechanical degradation or damage to the structure due to the strong crystallized nano-porous layers. This will drastically expand the application fields in which highly robust optical filters can be implemented.

The invention disclosed herein provides a relatively simple approach to achieve high robustness and high optical performance using conventional semiconductor fabrication methods. Therefore, the fabrication cost for this robust optical window is expected to be low.

Other aspects of the technology introduced here will be apparent from the accompanying figures and from the detailed description which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a basic optical filter with a crystallized nano-porous layer on a substrate.

FIG. 2A illustrates the formation of crystallized nano-porous layers by high temperature shadowing deposition.

FIG. 2B illustrates the formation of amorphous nano-porous layers at low temperatures.

FIG. 2C illustrates the formation of a crystallized dense layer at very high temperatures.

FIG. 3 illustrates the fabrication method of high temperature shadowing deposition to achieve crystallized nano-porous layers.

FIG. 4A is a scanning electron micrograph of a ZnSe crystallized nano-porous layer.

FIG. 4B is a scanning electron micrograph of a ZnSe amorphous nano-porous layer.

FIG. 5A illustrates a basic optical filter with a dense layer on top of a crystallized nano-porous layer.

FIG. 5B illustrates a basic optical filter showing a multi-layered crystallized nano-porous layer.

FIG. 5C illustrates a basic optical filter showing a crystallized nano-porous layer on top of a dense layer.

FIG. 6A illustrates a basic optical filter with a dense layer on top of crystallized nano-porous layers, in which the crystallized nano-porous layers have the same composition or material as the substrate.

FIG. 6B illustrates a basic optical filter with multi-layered crystallized nano-porous layers with the same composition or material as the substrate.

FIG. 6C illustrates a basic optical filter with a dense layer between the crystallized nano-porous layers and substrate, in which the crystallized nano-porous layers have the same composition or material as the substrate.

FIG. 7A illustrates a basic optical filter with a crystallized nano-porous layer of arbitrary shape and a dense layer on top.

FIG. 7B illustrates a basic optical filter showing a multi-layered crystallized nano-porous layer of arbitrary shape.

FIG. 7C illustrates a basic optical filter showing a crystallized nano-porous layer of arbitrary shape on top of a dense layer.

FIG. 8 illustrates an optical filter with an alternating sequence of crystallized nano-porous layers.

FIG. 9 illustrates a basic optical filter showing an alternating sequence of crystallized nano-porous layers with dense layers.

FIG. 10 illustrates the refractive index profile of an optical filter that contains crystallized nano-porous layers.

FIG. 11 illustrates an optical filter with multiple layers of crystallized nano-porous layers in which refractive index decreases for each successive layer.

FIG. 12 illustrates an optical filter that contains a crystallized nano-porous layer with a gradient refractive index profile.

FIG. 13A illustrates an optical filter with non-crystallized nano-porous layers inserted on top of crystallized nano-porous layers.

FIG. 13B illustrates an optical filter with non-crystallized nano-porous layers inserted in between crystallized nano-porous layers.

FIG. 13C illustrates an optical filter with non-crystallized nano-porous layers inserted below the crystallized nano-porous layers.

FIG. 14A illustrates an optical filter that contains crystallized nano-porous layers that do not increase in porosity with each successive layer.

FIG. 14B illustrates an optical filter that contains crystallized nano-porous layers with a dense layer inserted in between the crystallized nano-porous layers.

FIG. 15 illustrates an optical filter with crystallized nano-porous layers on one side of a substrates while dense layers are in between another side of the substrate and a high index material.

FIG. 16 illustrates an optical filter showing an alternating sequence of crystallized nano-porous layers with dense layers on more than one side of a substrate.

FIG. 17 illustrates an optical filter with multiple layers of crystallized nano-porous layers in which porosity increases for each successive layer on two sides of a substrate.

FIG. 18 illustrates two different optical filters using crystallized nano-porous layers coated on two different sides of a substrate.

### DETAILED DESCRIPTION

References in this description to “an embodiment”, “one embodiment”, or the like, mean that the particular feature, function, or characteristic being described is included in at least one embodiment of the present invention. Occurrences of such phrases in this description do not necessarily all refer to the same embodiment, nor are they necessarily mutually exclusive.

At least one embodiment of the present invention reveals a structural and fabrication method for optical filters with robust, crystallized nano-porous optical thin films on a substrate. The substrate can be any material with a surface that an optical filter can be coated on such as optical windows, detector surfaces, light source surfaces, or any other material that has a surface. The substrate and its surface can be made of any material, including, but not limited to dielectric, metallic, semiconductor, organic, and inorganic material such as, but not limited to, aluminum, copper, titanium, stainless steel, glass, quartz, fused silica, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, ZrO₂, Ge, GaAs, AlAs, AlGaAs, ZnSe, PET, polycarbonate, PMMA, acrylic glass or any combination thereof. The substrate surface can be flat, curved, patterned, nano-patterned, micro-patterned, roughened, etched, smooth, or any combination thereof.

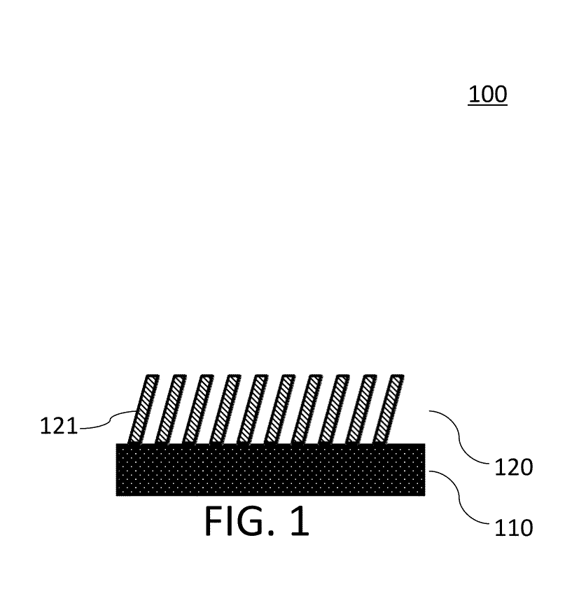

The basic structure of the robust crystallized nano-porous optical filter is shown in FIG. 1. The substrate is preferably transparent in the spectrum of interest such as the UV, visible, and/or IR. However, the substrate may also be reflective, opaque, absorbing, diffusive, or semi-transparent. The optical filter 100 includes a substrate 110. On substrate 110 a thin-film optical filter is deposited or grown, which consists of at least one or more crystallized nano-porous layers 120 with crystallized nano-features 121. The crystallized nano-porous layer 120 can be deposited using high temperature shadowing deposition from any optical material, such as, but not limited to, SiO₂, SiO, TiO₂, MgF₂, Al₂O₃, BaF₂, CaF₂, Si, Si₃N₄, GaN, AlN, InN, AlGaN, GaInN, ITO, SnO₂, In₂O₃, TiNbO, ZnO, ZrO₂, Ge, GaAs, AlAs, AlGaAs, ZnSe, PMMA, acrylic glass or a combination thereof. Crystallized nano-porous layers may contain voids on the nano-scale, micro-scale, or both. It is understood that the phrase crystallized nano-porous features may also include crystallized micro-porous features. Crystallized nano-porous layer 120 is preferably crystallized such as poly crystalline, micro crystalline, nano crystalline or single crystalline material on a substrate 110. The volume in between crystallized nano-features 121 and within crystallized nano-porous layer 120 can consist of vacuum or air. The crystallized nano-porous layer can also be immersed in different ambient material in which the volume in between crystallized nano-features can be filled with any media such as, but not limited to, gas, liquids, polymers, encapsulation material, epoxy, or silicone.

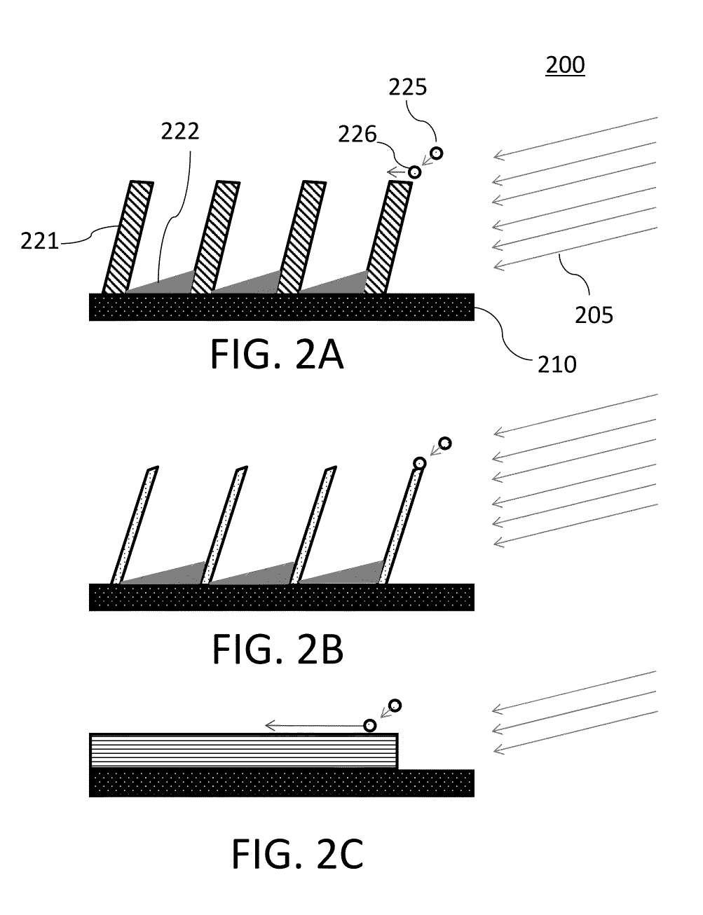

The formation of crystallized nano-porous layers by high temperature shadowing deposition is described in FIG. 2A. A vapor flux consisting of particles such as atoms, molecules, ions, and other forms of particles is incident upon a substrate at an elevated temperature. These vapor flux particles form deposits, nucleation sites, or islands on the substrate. Due to the off-normal incident angle with respect to the substrate surface normal and the directionality of the vapor flux, shadowing regions form between the deposits, nucleation sites, or islands. The vapor flux particles do not diffuse into the shadowing regions due to their low surface mobility. The lack of vapor flux particle diffusion in the shadowing region creates a void between the crystallized nano-porous features. These nano or micro-scale voids throughout the optical layer results in a porous layer. In high temperature shadowing deposition, the vapor flux particles on the substrate surface receive energy from the high temperature substrate so that they have high enough surface mobility and energy to be locally tightly packed or even locally crystallized forming crystallized nano-porous features. The crystallized nano-porous features can be partially or fully crystallized. The local crystalline phase may not necessarily be affected by the substrate material and will not completely recrystallize as seen in higher temperature processes such as annealing, epitaxy, and crystal growth. At these temperatures, the crystallization allows for the nano-porous features to become crystallized without the migration of energetic particles into the shadow region. For example, fluoride materials such as MgF₂, CaF₂, and BaF₂ can form crystalized nano-porous features at an elevated temperature range of 100° C. to 400° C. during high temperature shadowing deposition. ZnSe is another material that can be crystalized at an elevated temperature range of 100° C. to 350° C. during high temperature shadowing deposition. It is expected that many other materials can be crystallized at these low temperature ranges. Despite the fact that these temperature ranges are well below the materials' expected recrystallization temperature range (close to the melting point of the material), crystallized nano-porous features have been demonstrated. The highly dense and crystallized nano-porous features makes the nano-porous layer robust compared to non-crystallized nano-porous layers. If the surface mobility of the energetic particles is too small then no local crystallization will take place as shown in FIG. 2B. The energetic particles do not have enough surface mobility and energy to locally crystallize resulting in non-crystalline nano-porous features. For highly energetic processes in which complete recrystallization can take place, the surface mobility of the energetic particles is high enough to diffuse into the shadow region. At these high temperatures, no crystallized nano-features 221 will exist and instead a dense thin-film layer will be present as shown in FIG. 2C. The substrate temperature, during high temperature shadowing deposition, at which the formation of a crystallized nano-porous layer will occur is material dependent. For each material, the temperature should be chosen with a value that is high enough to allow local crystallization as shown in FIG. 2A while low enough to avoid particle diffusion into the shadowing region as shown in FIG. 2C.

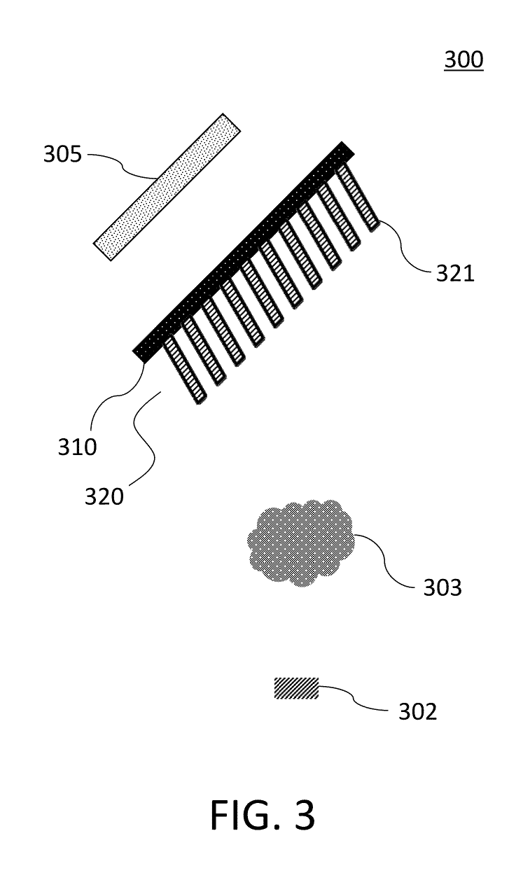

The preferred fabrication method 300 for high temperature shadowing deposition is shown in FIG. 3. An energy source 305 is used to heat the substrate and the energetic particles at the substrate to an elevated temperature. The temperature or energy of energy source 305 controls the surface diffusion of the energetic particles originating from vapor flux 303. Energy source 305 can be any source that can produce an elevated temperature such as an IR source, quartz lamp heater, or resistive heater. Energy source 305 can either be in contact or located away from substrate 310. The energy source 305 can transfer energy by convection, conduction, or radiation. The substrate can either be fixed without any motion or have motion, such as rotation, during the deposition. A source material 302 generates a vapor flux 303. The vapor flux can be generated through a deposition system such as a thermal or electron-beam evaporation system, ion-assisted evaporator, sputtering system, or pulsed laser deposition system. The vapor flux can be isotropic, directional, or any combination thereof. The tilt angle of substrate 310 with respect to vapor flux 303 leads to the porosity within crystallized nano-porous layer 320 that has crystallized nano-features 321. By changing the tilt angle of substrate 310 with respect to vapor flux 303, the porosity of crystallized nano-porous layer 320 can be changed. Therefore, crystallized nano-porous layer 320 of various porosities will result in various refractive index values.

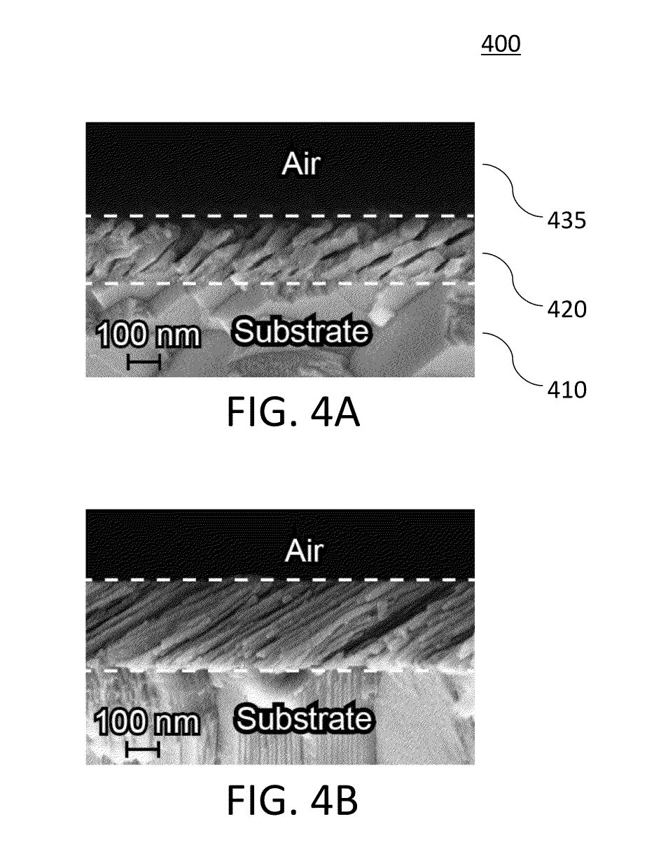

A scanning electron micrograph (SEM) image of a crystallized ZnSe nano-porous layer 420, fabricated by high temperature shadowing deposition, is shown in FIG. 4A. Crystallized facets are observed in crystallized nano-porous layer 420, which indicates that crystallized nano-porous layer 420 has at least partially crystallized. In contrast, an SEM image of an amorphous nano-porous layer on substrate 410 is shown in FIG. 4B. The amorphous ZnSe nano-porous layer is fabricated without an energy source as described in FIG. 3. The nano-porous features in FIG. 4B are amorphous and do not crystallize due to the low temperature deposition or growth method.

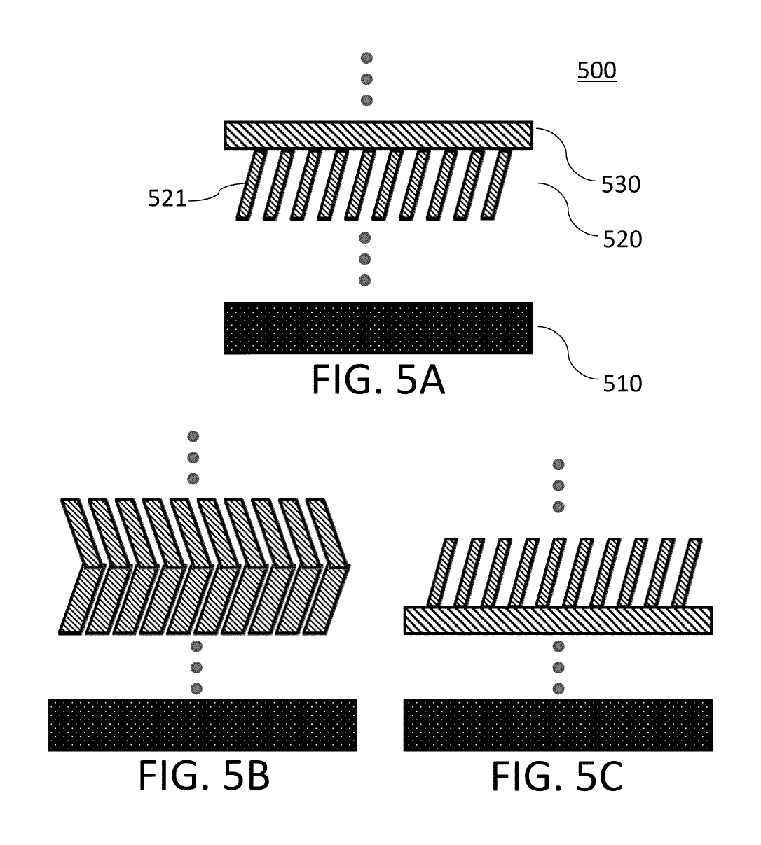

Another basic optical filter may consist of a multi-layer optical thin-film with at least one or more crystallized nano-porous layers. In FIG. 5A, at least one crystallized nano-porous layer with one or more dense layers is shown. The fabrication method for crystallized nano-porous layer is high temperature shadowing deposition. The dense layer fabrication can be any deposition or growth method such as, but not limited to chemical vapor deposition, physical vapor deposition, atomic layer deposition, or epitaxy growth. Dense layers can be amorphous, non-crystalline, crystalline, or any combination thereof. The dense layers can be composed of the same material or different materials as compared to crystallized nano-porous layer 520. These dense layers can be hard coatings, anti-scratch coatings, anti-smudge coatings, oleophobic coatings, hydrophobic coatings, hydrophilic coatings, anti-fog coatings, optical coatings, and adhesion promotion layers. Another preferred basic optical filter structure is shown in FIG. 5B. A crystallized nano-porous layer can consist of the same or different material compared to another crystallized nano-porous layer. A crystallized nano-porous layer can be the same or different porosity compared to another crystallized nano-porous layer. Another preferred optical filter design is shown in FIG. 5C in which the dense layers are deposited or grown closest to the substrate 510 and then crystallized nano-porous layers 520 are formed above the dense layer. These multi-layer optical thin-films can be embedded in any multi-layer thin-film stack. For example, above or below the multi-layer optical thin-film there may or may not exist additional optical layers as indicated by the dots in FIGS. 5A, 5B, and 5C. These additional optical layers can be amorphous, non-crystalline, crystalline, dense, nano-porous, porous, or any combination thereof.

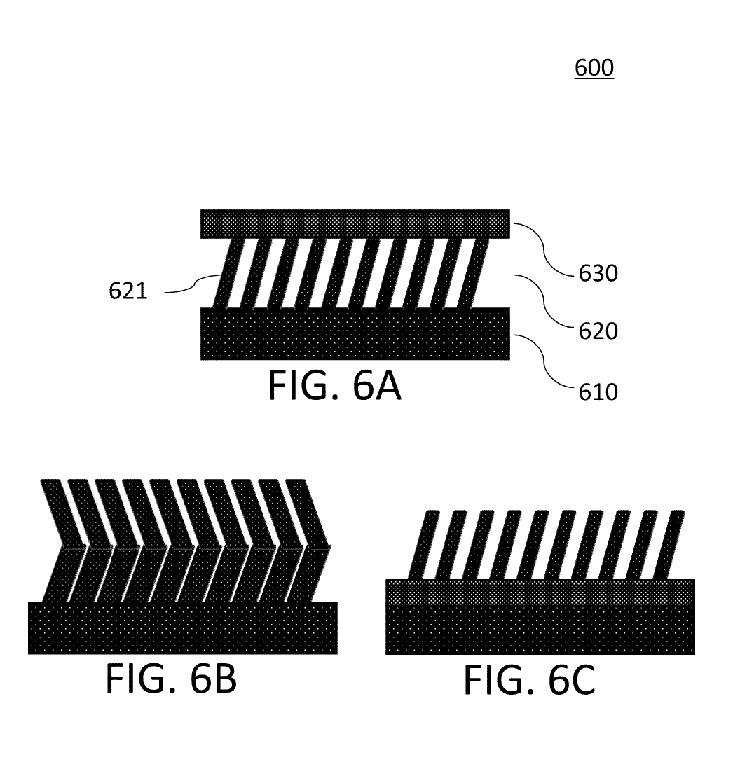

Another exemplary robust crystallized nano-porous optical filter is shown in FIG. 6A. The optical filter 600 is similar to basic optical filter 100 in FIG. 1 except that the crystallized nano-porous layers 620 are made of the same material as substrate 610. The multi-layer thin-film optical filter consists of at least one or more crystallized nano-porous layers 620 consisting of crystallized nano-features 621 on substrate 610. The fabrication method for crystallized nano-porous layer is high temperature shadowing deposition. The dense layer fabrication can be any deposition or growth method. Dense layers can be amorphous, non-crystalline, crystalline, or any combination thereof. Another preferred basic optical filter structure is shown in FIG. 6B. A crystallized nano-porous layer can consist of the same or different material compared to another crystallized nano-porous layer. A crystallized nano-porous layer can be the same or different porosity compared to another crystallized nano-porous layer. Another preferred optical filter design is shown in FIG. 6C in which dense layers 630 are first deposited or grown closest to substrate 610 and then crystallized nano-porous layers 620 are formed above the dense layer. These multi-layer optical thin-films can be embedded in any multi-layer thin-film stack as described in FIGS. 5A, 5B, and 5C.

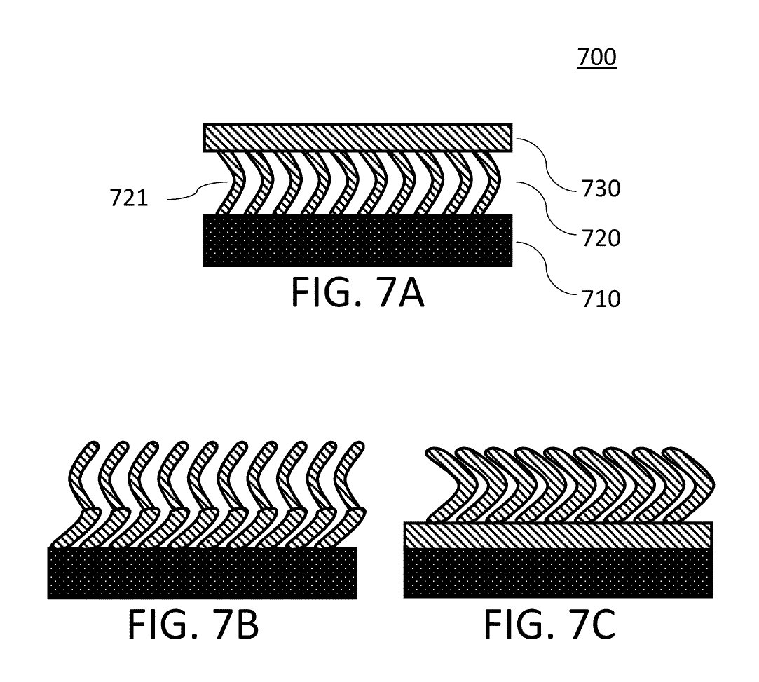

Another exemplary robust crystallized nano-porous optical filter is shown in FIG. 7A. On substrate 710 a thin-film optical filter consists of at least one or more crystallized nano-porous layers 720 of crystallized nano-features 721. Optical filter 700 is similar to that of optical filter 500 in FIG. 5 except the crystallized nano-porous layer 720 has crystallized nano-porous feature 721 of arbitrary shape. Methods to change the shape of crystallized nano-porous feature 721 involves changing the deposition conditions for crystallized nano-porous feature 721 while the optical filter 700 is exposed to a vapor flux 303 as described and shown in FIG. 3. Deposition condition changes that will lead to various crystallized nano-porous feature 721 shapes include substrate rotation, substrate temperature change, deposition rate change, pressure change, substrate tilt, or any combination thereof. Crystallized nano-porous feature 721 can be realized by rotating the substrate 710 perpendicularly to, parallel to, or any combination thereof with respect to the substrate 710 surface normal. The crystallized nano-porous feature 721 can be of any shape such as, but not limited to slanted nano-rods, zig-zag nano-rods, nano-spirals, or any combination thereof. For example, in FIG. 7A, crystallized nano-porous feature 721 can be realized by substrate rotation during high temperature shadowing deposition followed by a dense layer 730. In FIG. 7B, the porosity and/or the shape of the crystallized nano-porous layer changes as a function of thickness. A crystallized nano-porous layer can consist of the same or different material compared to another crystallized nano-porous layer. A crystallized nano-porous layer can be the same or different porosity compared to another crystallized nano-porous layer. Additionally, dense layers can be inserted between the substrate 710 and crystallized nano-porous layer 720 as shown in FIG. 7C. These multi-layer optical thin-films can be embedded in any multi-layer thin-film stack as described in FIGS. 5A, 5B, and 5C.

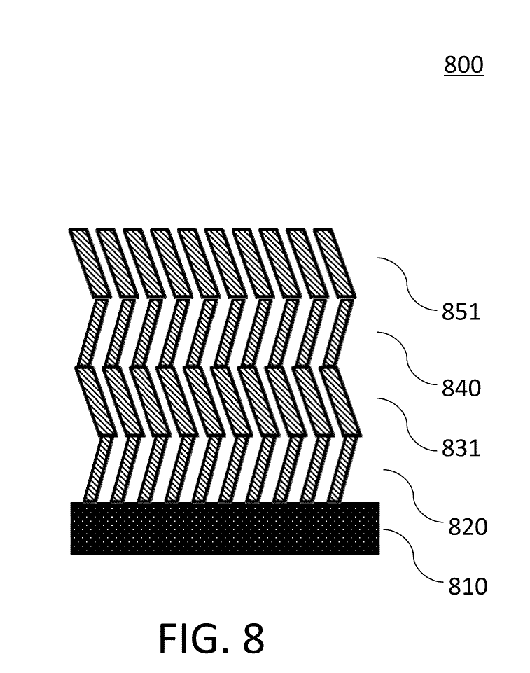

Another exemplary design of an optical filter 800 is shown in FIG. 8. The optical filter 800 can be used for a variety of optical functions including reflectors, distributed Bragg reflector (DBR), band-pass filters, dichroic filters, or anti-reflection coatings. The optical filter 800 shows an alternating sequence of crystallized nano-porous layers 820 and 840 with crystallized nano-porous layers 831 and 851 on a substrate 810. Crystallized nano-porous layers 831 and 851 are of similar material, porosity, or refractive index. Crystallized nano-porous layers 820 and 840 are of similar material, porosity, or refractive index. The crystallized nano-porous layers 831 and 851 are of different crystallized materials, porosities, or refractive index values compared to crystallized nano-porous layers 820 and 840. The crystallized nano-porous features in layer 820, 831, 840, and 851 can be slanted or oriented the same direction, alternatingly in opposite directions as shown in FIG. 8, randomly, or any direction. Layers 820, 831, 840, and 851 are deposited on substrate 810 by high temperature shadowing deposition. This alternating pattern of crystallized nano-porous layers, such as crystallized nano-porous layer 820 followed by another crystallized nano-porous layer 831 of a different material and/or porosity, can be repeated none, once, multiple times or indefinitely. Layers 820, 831, 840, and 851 can be coated on all, some, or only one side of substrate 810.

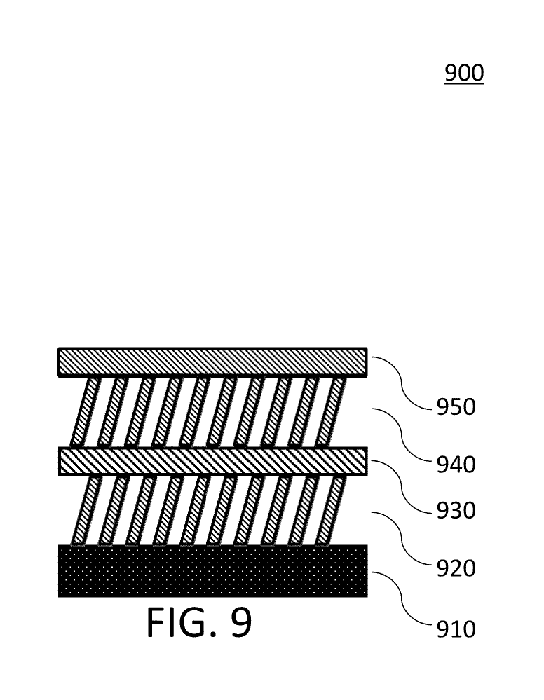

Another exemplary design of an optical filter 900 is shown in FIG. 9. The optical filter 900 can be used for a variety of optical functions including reflectors, distributed Bragg reflector (DBR), band-pass filters, dichroic filters or anti-reflection coatings. Optical filter 900 consists of a substrate 910, then a crystallized nano-porous layer 920 and a dense layer 930 followed by another crystallized nano-porous layer 940 and dense layer 950. The optical filter 900 shows an alternating sequence of crystallized nano-porous layers 920 and 940 with dense layers 930 and 950. Crystallized nano-porous features in layer 920, 940 can be slanted or oriented the same direction, alternatingly in opposite directions, randomly, or any direction. The optical filter 900 can consist of one or more pairs of alternating crystallized nano-porous layers 920 and dense layer 930. Crystallized nano-porous layers 920 and 940 are deposited on substrate 910 by high temperature shadowing deposition. The dense layer fabrication can be any deposition or growth method. Dense layers 930 and 950 can be amorphous, non-crystalline, crystalline, or any combination thereof.

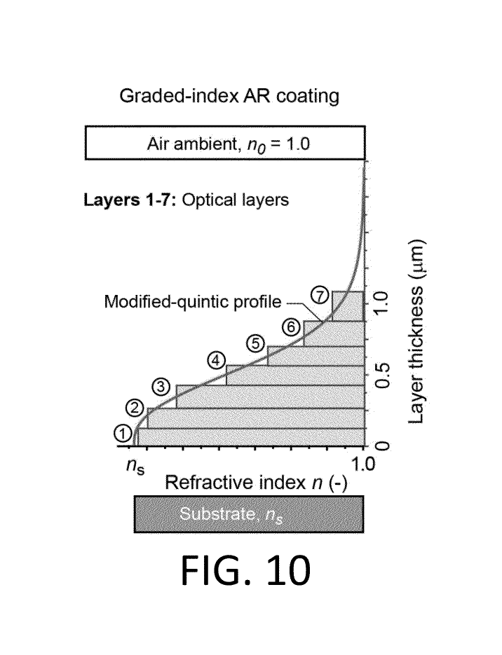

The refractive index profile of an optical filter that contains crystallized nano-porous layers is shown in FIG. 10. The number of crystallized nano-porous layers can be less, equal to, or greater than the seven layers shown in FIG. 10. The crystallized nano-porous layers form a refractive index profile that has a graded index change between the index of a substrate and the index of the surrounding ambient medium such as air, vacuum, gas, liquid, polymer, epoxy, silicone, or encapsulant. The preferred refractive index profile of the crystallized nano-porous layer is any graded index profile such as a linear, cubic, quintic, or modified quintic. In FIG. 10, the substrate has a multi-layer optical thin-film containing crystallized nano-porous layers in an air ambient. The refractive index of the optical layers in FIG. 10 follows a gradient profile such as the modified quintic profile. The example seven layer optical filter follows a graded refractive index profile in discrete refractive index steps. The refractive index of the layer closest to the substrate is highest while the refractive index of the layer furthest from the substrate in FIG. 10 has the lowest refractive index. The refractive index of the optical layers can also follow other graded-index or gradient-index profiles.

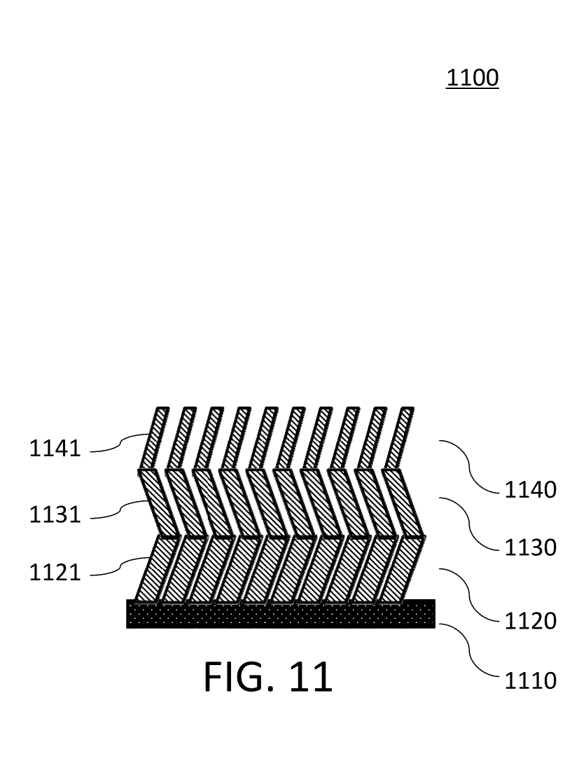

Another exemplary design of an optical filter 1100 is shown in FIG. 11. The optical filter 1100 can be used for a variety of optical functions but is particularly useful as an anti-reflection coating. The anti-reflective coating can be designed for the UV, visible, and/or IR spectra. Optical filter 1100 consists of a substrate 1110 followed by crystallized nano-porous layers 1120, 1130, and 1140 with crystallized nano-features 1121, 1131, and 1141, respectively. The optical filter can consist of less than, greater than, or equal to three crystallized nano-porous layers, as long as its index profile is a graded index profile. The refractive indices of the crystallized nano-porous layers 1120, 1130, 1140 can follow a graded refractive index profile as described in FIG. 10. Crystallized nano-porous layers 1120, 1130, and 1140 are deposited on substrate 1110 by high temperature shadowing deposition. Crystallized nano-porous layer 1120 can be the same or different material compared to substrate 1110. A crystallized nano-porous layer can consist of the same or different material compared to another crystallized nano-porous layer. A crystallized nano-porous layer can be the same or different porosity compared to another crystallized nano-porous layer. For example, one layer of the crystallized nano-porous layer can be MgF₂ and another crystallized layer can be BaF₂. The porosity of each crystallized nano-porous layer is changed in a way that the refractive index of each crystallized nano-porous layer decreases for each successive crystallized nano-porous layer. As a first example, the tilt angle is 45° during high temperature shadowing deposition of BaF₂, for the first crystallized nano-porous layer and then changed to 65° for the second BaF₂ crystallized nano-porous layer. In a second example, BaF₂ is deposited at 45° for the first crystallized nano-porous layer and then MgF₂ is deposited at 45° for the second crystallized nano-porous layer. In both examples, the refractive index of the second crystallized nano-porous layer is lower than the first crystallized nano-porous layer. The orientation of the crystallized nano-porous features for all layers can be slanted or oriented the same direction, alternatingly in opposite directions, randomly, or any direction.

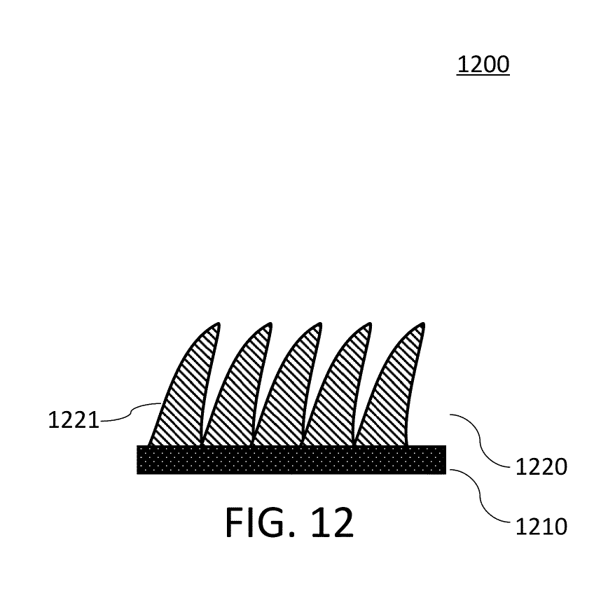

An optical filter with one or more gradient crystallized nano-porous layers is shown in FIG. 12. The refractive index of the crystallized nano-porous layers can follow a gradient refractive index profile as described in FIG. 10. A gradient refractive index profile is a smooth continuous refractive index change from substrate to ambient such as that illustrated in FIG. 12. Gradient refractive index profiles include any continuously decreasing refractive index profiles as a function of thickness including, but not limited to linear, cubic, quintic, Gaussian, modified-quintic profiles, or any combination thereof. The refractive index of the gradient crystallized nano-porous layer is largest closest to the substrate and decreases as a function of thickness away from the substrate. The gradient crystallized nano-porous layer is preferably made of the same material through the gradient layer, but can consist of different materials. The shape of the gradient crystallized nano-porous layer can be any shape in which the refractive index value follows closely to a gradient index profile.

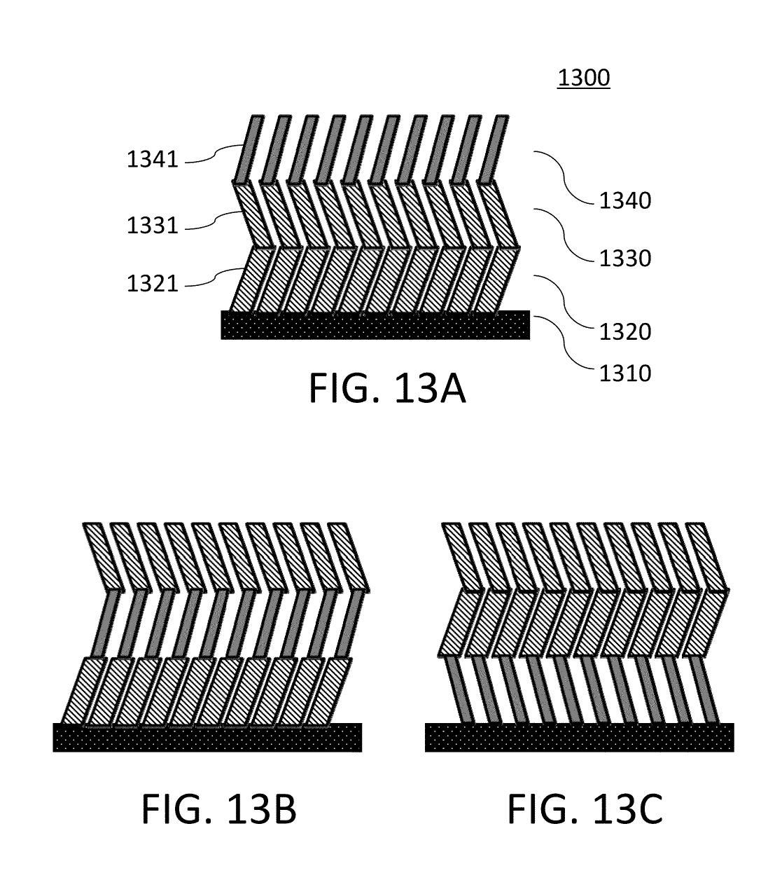

Another exemplary design of an optical filter 1300 is shown in FIG. 13A. Here the basic optical filter structure shown in FIG. 11 is the same structure shown in FIG. 13A except for additional nano-porous layers 1340. Initially, crystallized nano-porous layers 1320 and 1330 with nano-features 1321 and 1331, respectively, are fabricated by high temperature shadowing deposition on substrate 1310. Crystallized nano-porous layers 1320 and 1330 can consist of one or more crystallized nano-porous layers. Then to achieve further optical effects, at least one or more nano-porous layers 1340 can be deposited on top of crystallized nano-porous layers 1320 and 1330. The nano-porous layers 1340 can be deposited or grown by any method and do not have to be crystalline. The nano-porous layers 1340 have nano-features 1341 in which nano-porous layer 1340 can have porosities, refractive index values, or materials the same or different than crystallized nano-porous layer 1330 or 1320. In an anti-reflection coating design, for example, it would be desirable to use a nano-porous layer 1340 with a lower refractive index value compared to crystallized nano-porous layer 1330. Additionally, nano-porous layer 1340 can act as a surface modifier such as a hydrophobic or hydrophilic coating that changes the optical filter 1300 properties. Nano-porous layer 1340 can also be used to enhance the mechanical properties of optical filter 1300. Another exemplary design of optical filter 1300 is shown in FIG. 13B in which one or more nano-porous layers 1340 is inserted in between one or more crystalline nano-porous layers 1320 and 1330. In FIG. 13C, optical filter 1300 contains one or more nano-porous layers 1340 deposited or grown directly on or close to substrate 1310. Then crystallized nano-porous layers 1320 and 1330 are deposited by high temperature shadowing deposition on top of nano-porous layers 1340. It is understood that optical filter 1300 can contain any number of nano-porous layers 1340 that are not crystalline. Nano-porous layers 1340 can be deposited or grown on top of crystallized nano-porous layers 1320 and 1330, in between crystallized nano-porous layers 1320 and 1330, on the bottom of crystallized nano-porous layers 1320 and 1330, or any combination thereof.

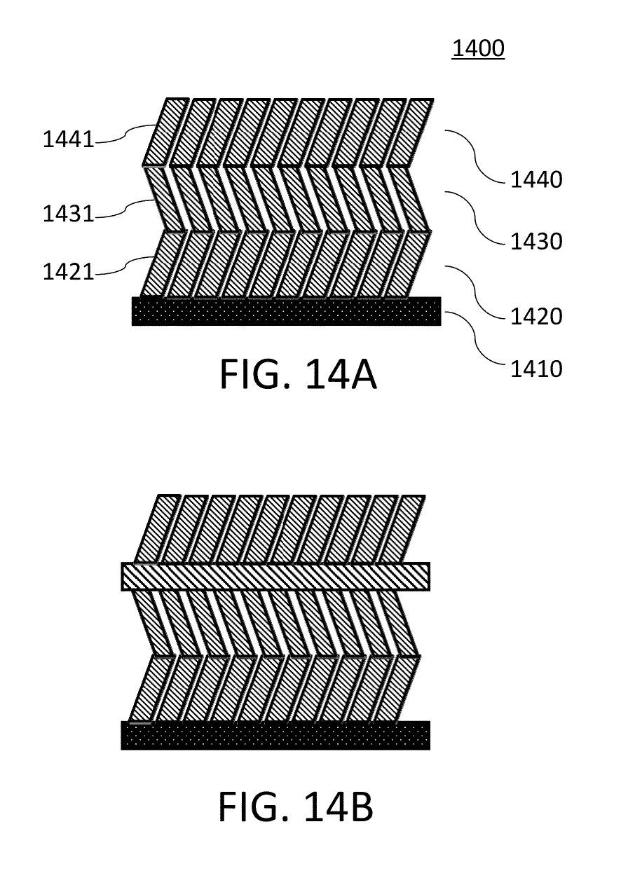

Another exemplary design of an optical filter 1400 is shown in FIG. 14A. FIG. 14A demonstrates the use of basic optical filter elements described in FIG. 1 and FIG. 5 to form a variety of optical filter designs. The optical filter 1400 shows a optical filter design consisting of a substrate 1410 followed by crystallized nano-porous layers 1420, 1430, and 1440 with crystallized nano-features 1421, 1431, and 1441, respectively. The optical filter 1100 shown in FIG. 11 differs from optical filter 1400 shown in FIG. 14A in that the porosities of nano-porous layers 1420, 1430, and 1440, do not increase sequentially. For example the top crystallized nano-porous layer 1440 has a lower porosity than the crystallized nano-porous layer 1430. This can be intentional based on the optical filter design. In FIG. 14B, a dense layer is inserted between crystallized nano-porous layers 1430 and 1440 to achieve a different optical filtering effect compared to the optical design shown in FIG. 14A. It is understood that many other optical filter combinations exist using at least one or more crystallized nano-porous layers.

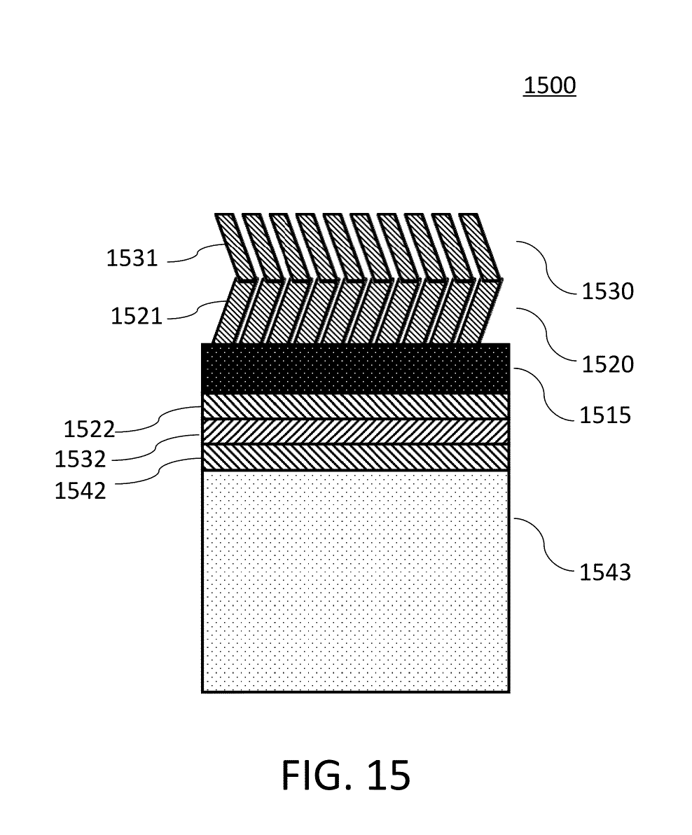

An optical filter design is shown in FIG. 15. The basic optical filter 1500 consists of at least one crystallized nano-porous layer on one side of a transparent substrate such as glass and at least one or more dense layers on another side of the transparent substrate. Crystallized nano-porous layers following a graded index profile are fabricated by high temperature shadowing deposition on one side of a substrate. On the other side of the substrate, at least one or more dense layers following a graded index profile is fabricated by any deposition or growth method. At least one dense layer 1522 exists with a refractive index value between that of the substrate 1515 and high index material 1543. Preferably, multiple dense layers are used following a graded index profile such that refractive index value of each successive layer increases between substrate 1515 and high index material 1543. In FIG. 15, the refractive index of dense layer 1522 is lower than the index of dense layer 1532 and the highest index is dense layer 1542. The material or composition for each dense layer will be different in order to reach a desired index value. The dense layers 1522, 1532, and 1542 on the substrate 1515 can be attached to the surface of a high index material 1543 such as those found on light-emitting diodes, OLEDs, lasers, optical resonant cavities, optical media, light pipes, optical fiber bundles, waveguides, silicone, epoxy, polymers, phosphor-mixed media, quantum-dot mixed media, or any combination thereof. The high index material 1543 can also be an encapsulant or lens made of transparent material such as silicone, epoxy, polymers, glass, quartz, polycarbonate, PET, plastic, polymers, or Teflon. The shape of the high index material 1543 can be any shape including hemispherical, semi-hemispherical, concave, convex, cubic, or any combination thereof.

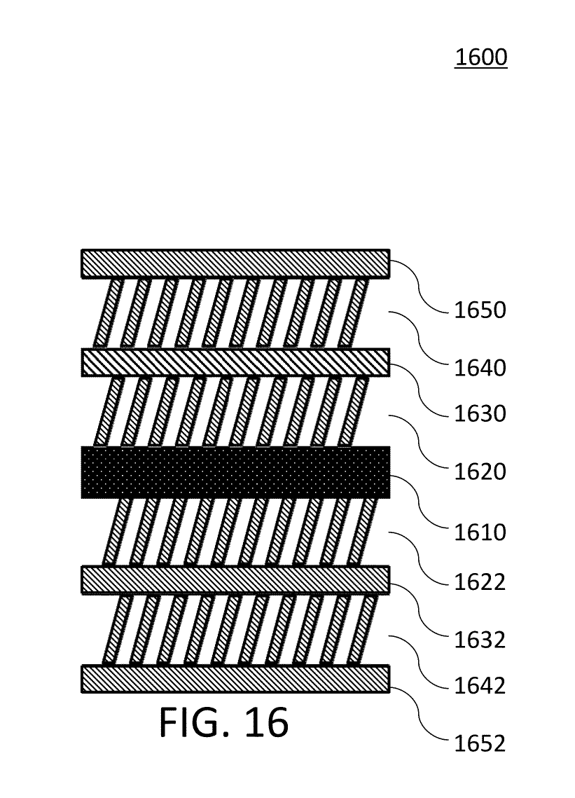

An optical filter alternating crystallized nano-porous layers 1620 and 1640 with dense layers 1630 and 1650 on at least two sides of a substrate is shown in FIG. 16. The substrate 1610 can be a light source that can consist of one or more light emitters or sources such as light-emitting diodes, OLEDs, lasers, optical resonant cavities, optical media, light pipes, optical fiber bundles, waveguides, or any object or medium that can emit light across any spectrum including at UV, visible, or IR wavelengths. A similar optical filter as shown in FIG. 9 is coated on two sides of the substrate 1610 in FIG. 16. The optical filters on both sides of substrate 1610 can be the same or different from each other. The optical filters can act as symmetric or asymmetric reflectors. Both optical filters can be highly reflective or partially reflective. The optical filter 1600 may also have an alternating sequence of first dense layers 1630 and 1650 followed by crystallized nano-porous layers 1620 and 1640, respectively, in which the dense layer 1630 is first deposited on substrate 1610. The optical filter on one side of the substrate can have the same or different number of layers, layer thicknesses, refractive index values, or materials compared to the optical filter on another side of the substrate 1610.

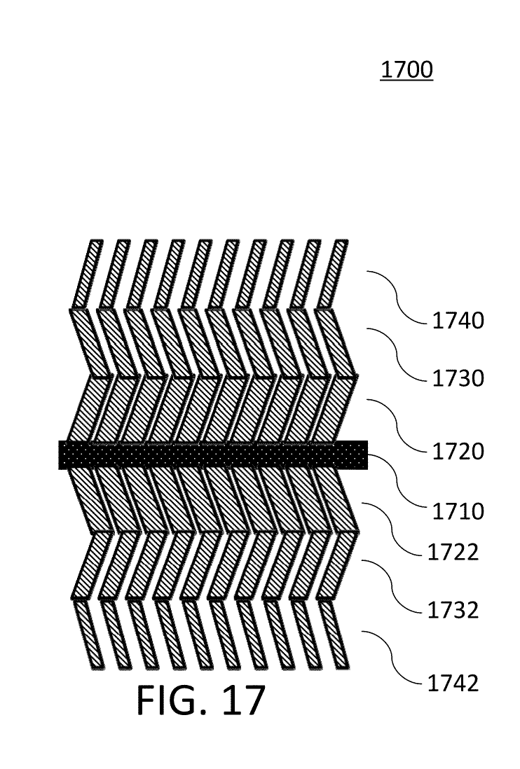

An optical filter with multi-layer crystallized nano-porous layers 1720, 1730, 1740, 1722, 1732, and 1742 are deposited on two sides of substrate 1710. The number of crystallized nano-porous layers can be less, equal to, or greater than the three layers shown in FIG. 17. A similar optical filter as shown in FIG. 11 is coated on two sides of the substrate 1710 shown in FIG. 17. Optical filter 1700 is particularly useful as transparent optical window when coated on both sides with an anti-reflective coating as in FIG. 11.The anti-reflective coating can be designed for the UV, visible, and/or IR spectra. The crystallized nano-porous layer coatings on each side of the substrate can be the same or different in terms of number of layers, layer thicknesses, refractive index values, or material. A crystallized nano-porous layer can consist of the same or different material compared to another crystallized nano-porous layer. A crystallized nano-porous layer can be the same or different porosity compared to another crystallized nano-porous layer. The crystallized nano-porous layer material can be the same or different from the substrate. The coatings on both sides can be symmetric or asymmetric with respect to each other. The preferred refractive index profile of the crystallized nano-porous layer is any graded or gradient refractive index profile as described in FIG. 10. An example optical filter can be a three-layer MgF₂ crystallized nano-porous coating on two sides of a glass, quartz, or fused silica substrate. Another example can be a two-layer silicon crystallized nano-porous coating on two sides of a silicon substrate, which can be transparent in the IR spectrum. Another example can be a seven-layer ZnSe crystallized nano-porous coating on two sides of a ZnSe substrate, which can be transparent in the IR spectrum.

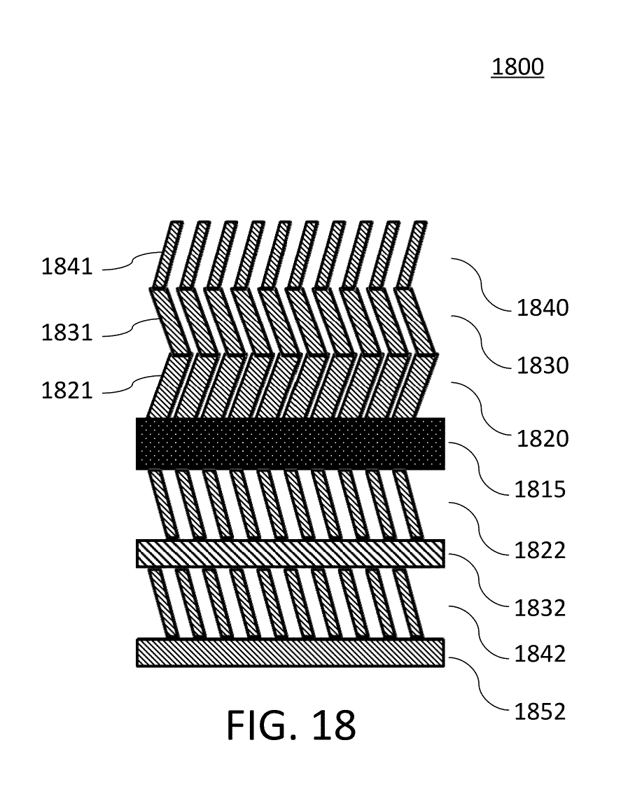

Another exemplary design of an optical filter 1800 is shown in FIG. 18. The optical filter 1800 shows a design for combining multiple optical filtering functions such as a reflector, band-pass filter, or dichroic filter with an anti-reflection optical coating as shown FIG. 11. Optical filter 1800 consists of a substrate 1815 followed by crystallized nano-porous layers 1820, 1830, and 1840 with crystallized nano-features 1821, 1831, and 1841, respectively on one side of the substrate 1815. On the other side of substrate 1815 a coating of first a crystallized nano-porous layer 1822 followed by a dense layer 1832 followed by another crystallized nano-porous layer 1842 and finally followed by a dense layer 1852. Layers 1820, 1830, 1840, 1822, and 1842 are deposited on substrate 1815 by high temperature shadowing deposition.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What med is:

1. An apparatus comprising:
a light-transmitting substrate; and
an optical coating deposited on the light-transmitting substrate, the optical coating including at least one crystallized nano-feature layer;
wherein the at least one crystallized nano-feature layer is deposited using high temperature oblique angle deposition and has a refractive index lower than a refractive index of the light-transmitting substrate.

2. The apparatus of claim 1, wherein the optical coating includes a plurality of crystallized nano-feature layers, and each layer of the plurality of crystallized nano-feature layers has a refractive index different from refractive indices of immediately adjacent crystallized nano-feature layers.

3. The apparatus of claim 1, wherein the at least one crystallized nano-feature layer is optically transparent -.

4. The apparatus of claim 1, wherein the refractive index of the at least one crystallized nano-feature layer is higher than the refractive index of air.

5. The apparatus of claim 1, wherein the at least one crystallized nano-feature layer includes crystallized nano-porous features.

6. The apparatus of claim 1, wherein the at least one crystallized nano-feature layer includes crystallized nano-porous features that have tilt angles, and the tilt angles of the crystallized nano-porous features do not deviate more than 10° from each other.

6. The apparatus of claim 1, wherein the optical coating includes a plurality of thin film layers, the plurality of thin film layers includes the at least one crystallized nano-feature layer; and
wherein each thin film layer of the plurality of thin film layers has a refractive index, and the refractive indices of the plurality of thin film layers decreases with a distance between the light-transmitting substrate and corresponding thin film increases.

7. The apparatus of claim 6, wherein the refractive index of a thin film layer in direct contact with the light-transmitting substrate of the plurality of thin film layers is lower than a refractive index of the light-transmitting substrate.

8. The apparatus of claim 6, wherein the refractive index of a thin film layer furthest from the light-transmitting substrate among the plurality of thin film layers is higher than the refractive index of air

9. The apparatus of claim 1, wherein the at least one crystallized nano-feature layer is a gradient index layer that has a gradient refractive index, and wherein the gradient refractive index of the layer decreases as a distance to the light-transmitting substrate increases.

10. The apparatus of claim 9, wherein the gradient index layer has a refractive index profile that is a linear, quintic, or Gaussian function of the distance to the light-transmitting substrate.

11. The apparatus of claim 9, wherein the gradient index layer further has a gradient porosity, and wherein the gradient porosity of the layer increases as the distance to the light-transmitting substrate increases.

12. An apparatus comprising:
a light-transmitting substrate; and
an optical coating deposited on top of the light-transmitting substrate, the optical coating including a plurality of pairs of alternating thin film layers;
wherein at least one thin film layer of each pair of alternating thin film layers is a crystallized nano-feature layer deposited using high temperature oblique angle deposition; and
wherein each pair of alternating thin film layers has two thin film layers that have different refractive indices.

13. The apparatus of claim 12, wherein each pair of alternating thin film layers includes a crystallized nano-feature layer and a dense thin film.

14. The apparatus of claim 12, wherein each pair of alternating thin film layers includes two crystallized nano-feature layers that have two different porosities.

15. The apparatus of claim 12, wherein each pair of alternating thin film layers includes two crystallized nano-feature layers, one of the two crystallized nano-feature layers includes a material that is different from another material of the other layer.

16. The apparatus of claim 12, wherein each pair of alternating thin film layers includes a crystallized nano-feature layer and a non-crystallized nano-feature layer.

17. An apparatus comprising:
a light-transmitting substrate; and
an optical coating deposited on the light-transmitting substrate, the optical coating including a crystallized nano-feature layer;
wherein the crystallized nano-feature layer is deposited by a process including:
generating a material flux by a deposition system having a nominal flux direction toward a substrate, wherein a tilt angle between the nominal flux direction and a plane normal vector of the substrate is substantially larger than zero,
depositing material on the substrate by the material flux to grow nano-porous features, and
heating the substrate to a predetermined temperature such that the nano-porous features at least partially crystallize on the substrate.

18. The apparatus of claim 17, wherein the heating comprises:
heating the substrate to a predetermined temperature such that the nano-porous features crystallize on the substrate.

19. The apparatus of claim 17, wherein the generating, depositing, and heating are conducted simultaneously.

20. The apparatus of claim 17, wherein the process further includes:
rotating the substrate.

21. The apparatus of claim 17, wherein the material flux includes SiO2, SiO, TiO2, MgF2, Al2O3, BaF2, CaF2, Si, Si3N4, GaN, AlN, InN, AlGaN, GaInN, ITO, SnO2, In2O3, TiNbO, ZnO, ZrO2, Ge, GaAs, AlAs, AlGaAs, ZnSe, PMMA, or acrylic glass.

22. The apparatus of claim 17, wherein the deposition system is a thermal evaporation system, an electron-beam evaporation system, sputtering system, or a pulsed laser deposition system.
